(19) United States
(12) Patent Application Publication
(10) Pub. No.: US 2024/0228312 A1
(43) Pub. Date: Jul. 11, 2024

(54) PREPARATION METHOD OF SPHERICAL ALUMINA WITH LOW VISCOSITY AND HIGH THERMAL CONDUCTIVITY

(71) Applicant: Novoray Corporation, Lianyungang (CN)

(72) Inventors: Xiaodong LI, Lianyungang (CN); Bing JIANG, Lianyungang (CN); Huan ZHAO, Lianyungang (CN); Xue LIU, Lianyungang (CN); Shicheng HU, Lianyungang (CN)

(21) Appl. No.: 17/998,597

(22) PCT Filed: Aug. 23, 2022
(86) PCT No.: PCT/CN2022/114075

§ 371 Date: Nov. 11, 2022

(30) Foreign Application Priority Data
Sep. 14, 2021 (CN) 202111076258.6

(51) Int. Cl. C01F 7/021

(52) U.S. Cl. CPC C01F 7/021; C01P 2004/32; C01P 2004/61; C01P 2006/32

(57) ABSTRACT

The present disclosure provides a preparation method of spherical α-alumina with a low viscosity and a high thermal conductivity. In the preparation method, a spherical α-alumina powder is obtained through spheroidization by melting using an angular α-alumina powder as a raw material; and the spherical α-alumina powder is calcined at a high temperature to obtain the spherical α-alumina with a low viscosity and a high thermal conductivity. In the present disclosure, a spheroidization rate and an α-phase are kept unchanged by adjusting a calcination temperature and a calcination time, while improving the thermal conductivity of the alumina and not affecting a viscosity of products such as thermal conductive films prepared from the alumina as a filler.

### CROSS REFERENCE TO RELATED APPLICATION

The present disclosure claims priority of Chinese Patent Application No. 202111076258.6 filed to the China National Intellectual Property Administration (CNIPA) on Sep. 14, 2021 and entitled “PREPARATION METHOD OF SPHERICAL α-ALUMINA WITH LOW VISCOSITY AND HIGH THERMAL CONDUCTIVITY”, which is incorporated herein by reference in its entirety.

### TECHNICAL FIELD

The present disclosure belongs to the technical field of preparation of thermally conductive fillers, and in particular relates to a preparation method of spherical α-alumina with a low viscosity and a high thermal conductivity.

### BACKGROUND

With the rapid development of science and technology, electronic products such as notebooks tend to be thin and provide more performance. The vigorous development of new energy vehicles in recent years results in many new changes in the requirements for auxiliary power supply products. From the most basic use of batteries to charging electrical appliances, these power supply products all have the problem of internal heat generation. An increase in the power of electronic devices is usually accompanied with an increase in the requirements for heat dissipation capacity, which in turn requires an increasingly high thermal conductivity of commonly-used heat dissipation fillers.

As the most commonly-used thermally conductive filler material, spherical alumina has a relatively high cost performance. Chinese patent CN113184886A disclosed a preparation method of spherical alumina with a high thermal conductivity and a product. The preparation method includes the following steps: adding an additive to ordinary spherical alumina by weight, and mixing uniformly to obtain a primary product; conducting calcination on the primary product in a high-temperature furnace at 1,250° C. to 1,600° C. for 8 h to 22 h, and cooling to obtain an intermediate product; and dispersing the intermediate product by grinding in a crusher to obtain a spherical alumina product with a high thermal conductivity and an α-phase content of 100%. However, in the preparation method, the additive tends to introduce unnecessary impurities. Moreover, although the calcination can increase the α-phase content of spherical alumina, the excessively high calcination temperature and excessively long calcination time may lead to an increased viscosity of the spherical alumina, thereby affecting the performance of downstream products.

### SUMMARY

An objective of the present disclosure is to provide a preparation method of spherical α-alumina with a low viscosity and a high thermal conductivity. In the preparation method, a spherical α-alumina powder obtained through spheroidizing by melting is calcined at a high temperature. A spheroidization rate and an α-phase are kept unchanged by adjusting a calcination temperature and a calcination time, while improving the thermal conductivity of the alumina and not affecting a viscosity of products such as thermal conductive films prepared from the alumina as a filler.

The technical solution to achieve the objective of the present disclosure is as follows:

The present disclosure provides a preparation method of spherical α-alumina with a low viscosity and a high thermal conductivity, including the following steps:
step 1: conducting spheroidization on an angular α-alumina powder by melting at 2,100° C. to 2,400° ° C. to obtain a spherical α-alumina powder; and
step 2: conducting calcination on the spherical α-alumina powder at 1,000° C. to 1,200° ° C. for 1 h to 6 h to obtain the spherical α-alumina with a low viscosity and a high thermal conductivity.

Preferably, in step 1, the spherical α-alumina powder has the average particle size of not less than 45 μm, more preferably 45 μm to 120 μm.

Preferably, in step 1, the angular α-alumina powder has an α-alumina powder with a purity of not less than 99.8%.

Preferably, in step 1, the spheroidization is conducted at 2,200° ° C. to 2,300° C.

Preferably, in step 2, the calcination is conducted at 1,000° C. to 1,100° C.

Preferably, in step 2, the calcination is conducted in a tunnel kiln.

Preferably, in step 2, when the spherical α-alumina powder has the average particle size of 45 μm, the calcination is conducted at 1,000° ° C. for 6 h.

Preferably, in step 2, when the spherical α-alumina powder has the average particle size of 70 μm or 90 μm, the calcination is conducted at 1,100° C. for 2 h.

Preferably, in step 2, when the spherical α-alumina powder has the average particle size of 120 μm, the calcination is conducted at 1,100° C. for 1 h.

In the present disclosure, the thermally conductive spherical α-alumina is prepared using the spherical α-alumina obtained through spheroidization by melting as a calcining raw material, with a spheroidization rate of not less than 93%. It is unexpectedly found that by strictly controlling the calcination temperature and calcination time, a thermal conductivity of the spherical alumina with an average particle size of not less than 45 μm can be significantly improved by 5% to 10%; meanwhile, the increased viscosity and affected product performance are avoided in the field of downstream products such as thermal conductive films prepared by the spherical alumina as a filler due to an excessive calcination temperature. The spherical α-alumina can be widely used in the fields of thermally conductive insulating materials and electronic materials due to an excellent fluidity, a large filling amount, a high thermal conductivity, and a low viscosity.

### DETAILED DESCRIPTION OF THE EMBODIMENTS

In order to further describe the present disclosure, the present disclosure is described in detail below with reference to the examples, but the examples should not be understood as limiting the protection scope of the present disclosure.

### Example 1

Commercially-available angular α-alumina as a raw material was subjected to spheroidization by melting in a high-temperature spheroidizing furnace at 2,100° C. to 2,400° C., and sieved to an average particle size of 45 μm to obtain a test sample 1-1;
the test sample 1-1 was heated in a tunnel kiln at 1,000° C. for 6 h to obtain a test sample 1-2;
the test sample 1-1 was heated in a tunnel kiln at 1,050° C. for 6 h to obtain a test sample 1-3;
the test sample 1-1 was heated in a tunnel kiln at 1,100° ° C. for 6 h to obtain a test sample 1-4;
the test sample 1-1 was heated in a tunnel kiln at 1,150° C. for 6 h to obtain a test sample 1-5;
the test sample 1-1 was heated in a tunnel kiln at 1,200° ° C. for 6 h to obtain a test sample 1-6;
the test sample 1-1 was heated in a tunnel kiln at 1,300° C. for 6 h to obtain a test sample 1-7; and
the test sample 1-1 to test sample 1-7 were measured in a specific system by a thermal conductivity meter and a rotational viscometer, and obtained data were listed in Table 1.

### Example 2

Commercially-available angular α-alumina as a raw material was subjected to spheroidization by melting in a high-temperature spheroidizing furnace at 2,100° ° C. to 2,400° C., and sieved to an average particle size of 70 μm to obtain a test sample 2-1;
the test sample 2-1 was heated in a tunnel kiln at 1,000° C. for 2 h to obtain a test sample 2-2;
the test sample 2-1 was heated in a tunnel kiln at 1,050° C. for 2 h to obtain a test sample 2-3;
the test sample 2-1 was heated in a tunnel kiln at 1,100° ° C. for 2 h to obtain a test sample 2-4;
the test sample 2-1 was heated in a tunnel kiln at 1,150° C. for 2 h to obtain a test sample 2-5;
the test sample 2-1 was heated in a tunnel kiln at 1,200° ° C. for 2 h to obtain a test sample 2-6;
the test sample 2-1 was heated in a tunnel kiln at 1,300° ° C. for 2 h to obtain a test sample 2-7; and
the test sample 2-1 to test sample 2-7 were measured in a specific system by a thermal conductivity meter and a rotational viscometer, and obtained data were listed in Table 1.

### Example 3

Commercially-available angular α-alumina as a raw material was subjected to spheroidization by melting in a high-temperature spheroidizing furnace at 2,100° ° C. to 2,400° C., and sieved to an average particle size of 90 μm to obtain a test sample 3-1; the test sample 3-1 was heated in a tunnel kiln at 1,000° ° C. for 2 h to obtain a test sample 3-2; the test sample 3-1 was heated in a tunnel kiln at 1,050° C. for 2 h to obtain a test sample 3-3; the test sample 3-1 was heated in a tunnel kiln at 1,100° C. for 2 h to obtain a test sample 3-4; the test sample 3-1 was heated in a tunnel kiln at 1,150° C. for 2 h to obtain a test sample 3-5; the test sample 3-1 was heated in a tunnel kiln at 1,200° ° C. for 2 h to obtain a test sample 3-6; the test sample 3-1 was heated in a tunnel kiln at 1,300° ° C. for 2 h to obtain a test sample 3-7; and the test sample 3-1 to test sample 3-7 were measured in a specific system by a thermal conductivity meter and a rotational viscometer, and obtained data were listed in Table 1.

### Example 4

Commercially-available angular α-alumina as a raw material was subjected to spheroidization by melting in a high-temperature spheroidizing furnace at 2,100° C. to 2,400° ° C., and sieved to an average particle size of 120 μm to obtain a test sample 4-1; the test sample 4-1 was heated in a tunnel kiln at 1,000° C. for 1 h to obtain a test sample 4-2; the test sample 4-1 was heated in a tunnel kiln at 1,050° C. for 1 h to obtain a test sample 4-3; the test sample 4-1 was heated in a tunnel kiln at 1,100° ° C. for 1 h to obtain a test sample 4-4; the test sample 4-1 was heated in a tunnel kiln at 1,150° C. for 1 h to obtain a test sample 4-5; the test sample 4-1 was heated in a tunnel kiln at 1,200° C. for 1 h to obtain a test sample 4-6; the test sample 4-1 was heated in a tunnel kiln at 1,300° C. for 1 h to obtain a test sample 4-7; and the test sample 4-1 to test sample 4-7 were measured in a specific system by a thermal conductivity meter and a rotational viscometer, and obtained data were listed in Table 1.

Thermally conductive gaskets were prepared using the samples prepared in each example as thermally conductive fillers. For each thermally conductive gasket, the thermal conductivity was measured using a thermal conductivity meter, and the rotational viscosity was measured using a rotational viscometer according to GB/T 2794-2013 “Determination for viscosity of adhesives. Single cylinder rotational viscometer method”. The results were shown in Table 1.

TABLE 1
Thermal conductivity and rotational viscosity data
of test samples prepared in Examples 1 to 4

| | Thermal conductivity | Rotational viscosity |
|---|---|---|
| Test samples | W/mk % | cp % |
| 1-1 | 1.00 | 1.00 |
| 1-2 | 1.05 | 1.02 |
| 1-3 | 1.11 | 1.02 |
| 1-4 | 1.01 | 1.05 |
| 1-5 | 1.02 | 1.07 |
| 1-6 | 0.99 | 1.06 |
| 1-7 | 1.03 | 1.07 |
| 2-1 | 1.00 | 1.00 |
| 2-2 | 0.99 | 1.01 |
| 2-3 | 1.04 | 1.02 |
| 2-4 | 1.07 | 1.01 |
| 2-5 | 1.03 | 1.03 |
| 2-6 | 1.01 | 1.05 |
| 2-7 | 1.02 | 1.08 |
| 3-1 | 1.00 | 1.00 |
| 3-2 | 1.01 | 0.99 |
| 3-3 | 1.02 | 1.02 |
| 3-4 | 1.09 | 1.01 |
| 3-5 | 1.05 | 1.03 |
| 3-6 | 1.00 | 1.03 |
| 3-7 | 1.03 | 1.05 |
| 4-1 | 1.00 | 1.00 |
| 4-2 | 1.01 | 1.01 |
| 4-3 | 1.02 | 1.01 |
| 4-4 | 1.08 | 1.00 |
| 4-5 | 1.03 | 1.03 |
| 4-6 | 1.00 | 1.04 |
| 4-7 | 1.02 | 1.06 |

It was seen from the above data that the test samples 1-2, 2-4, 3-4, and 4-4 each exhibited a high thermal conductivity and a low rotational viscosity, with the best overall performance.

The above described are merely specific implementations of the present disclosure, and the protection scope of the present disclosure is not limited thereto. Any modification or replacement easily conceived by those skilled in the art within the technical scope of the present disclosure should fall within the protection scope of the present disclosure. Therefore, the protection scope of the present disclosure shall be subject to the protection scope of the claims.

1. A preparation method of spherical α-alumina with a low viscosity and a high thermal conductivity, comprising the following steps:
step 1: conducting spheroidization on an angular α-alumina powder by melting at 2,100° ° C. to 2,400° ° C. to obtain a spherical α-alumina powder; and
step 2: conducting calcination on the spherical α-alumina powder at 1,000° C. to 1,200° C. for 1 h to 6 h to obtain the spherical α-alumina with a low viscosity and a high thermal conductivity.

2. The preparation method according to claim 1, wherein in step 1, the angular α-alumina powder has an average particle size of not less than 45 μm.

3. The preparation method according to claim 1, wherein in step 1, the spherical α-alumina powder has an average particle size of 45 μm to 120 μm.

4. The preparation method according to claim 1, wherein in step 1, the spherical α-alumina powder has the average particle size of 45 μm, 70 μm, 90 μm, or 120 μm.

5. The preparation method according to claim 1, wherein in step 1, the angular α-alumina powder is an α-alumina powder with a purity of not less than 99.8%.

6. The preparation method according to claim 1, wherein in step 1, the spheroidization is conducted by melting at 2,200° ° C. to 2,300° C.

7. The preparation method according to claim 1, wherein in step 2, the calcination is conducted at 1,000° ° C. to 1,100° C.

8. The preparation method according to claim 1, wherein in step 2, the calcination is conducted in a tunnel kiln.

9. The preparation method according to claim 1, wherein in step 2, when the spherical α-alumina powder has the average particle size of 45 μm, the calcination is conducted at 1,000° ° C. for 6 h.

10. The preparation method according to claim 1, wherein in step 2, when the spherical α-alumina powder has the average particle size of 70 μm or 90 μm, the calcination is conducted at 1,100° C. for 2 h.

11. The preparation method according to claim 1, wherein in step 2, when the spherical α-alumina powder has the average particle size of 120 μm, the calcination is conducted at 1,100° C. for 1 h.

12. The preparation method according to claim 1, wherein in step 1, the spheroidization is conducted by melting at 2,200° ° C. or 2,300° C.

13. The preparation method according to claim 4, wherein in step 2, when the spherical α-alumina powder has the average particle size of 45 μm, the calcination is conducted at 1,000° ° C. for 6 h.

14. The preparation method according to claim 4, wherein in step 2, when the spherical α-alumina powder has the average particle size of 70 μm or 90 μm, the calcination is conducted at 1,100° ° C. for 2 h.

15. The preparation method according to claim 4, wherein in step 2, when the spherical α-alumina powder has the average particle size of 120 μm, the calcination is conducted at 1,100° C. for 1 h.

16. The preparation method according to claim 5, wherein in step 1, the spheroidization is conducted by melting at 2,200° ° C. or 2,300° C.

17. The preparation method according to claim 2, wherein in step 1, the spherical α-alumina powder has the average particle size of 45 μm, 70 μm, 90 μm, or 120 μm.

18. The preparation method according to claim 3, wherein in step 1, the spherical α-alumina powder has the average particle size of 45 μm, 70 μm, 90 μm, or 120 μm.

19. The preparation method according to claim 2, wherein in step 1, the angular α-alumina powder is an α-alumina powder with a purity of not less than 99.8%.

20. The preparation method according to claim 7, wherein in step 2, the calcination is conducted in a tunnel kiln.
